(19) United States
(12) Patent Application Publication
(10) Pub. No.: US 2005/0258406 A1
(43) Pub. Date: Nov. 24, 2005

(54) Black resist composition for color filter

(75) Inventors: Mina Onishi, Kanagawa (JP); Masanao Kamijo, Kanagawa (JP); Katsumi Murofushi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K.

(21) Appl. No.: 11/128,167

(22) Filed: May 13, 2005

Related U.S. Application Data
(60) Provisional application No. 60/572,947, filed on May 21, 2004.

(30) Foreign Application Priority Data
May 13, 2004 (JP) 2004-143230

(51) Int. Cl. F21V 9/00

(52) U.S. Cl. 252/582

(57) ABSTRACT

The present invention relates to a black resist composition for color filter which contains titanium black (A) with an average primary particle size of 100 nm, carbon black (B) with an average primary particle size of 60 nm or less, an acrylic copolymer dispersant (C) with an amino group and/or a quaternary ammonium salt, an organic solvent (D) and a binder resin (E) with a carboxyl group and an ethylenic unsaturated group, where the ratio in mass between the titanium black (A) and the titanium black (B) is 100:5 to 1000. According to the black resist composition for color filter of the present invention, patterns can readily be formed by photolithography, and the composition has high light resistance and high insulation property, and can be made into a thin film to attain sufficient sensitivity and resolution property.

### CROSS REFERENCE TO THE RELATED APPLICATIONS

This is an application filed pursuant to 35 U.S.C. Section 111(a) with claiming the benefit of U.S. Provisional application Ser. No. 60/572, 947 filed May 21, 2004 under the provision of 35 U.S.C. Section 111(b), pursuant to 35 U.S.C. Section 119(e) (1).

### TECHNICAL FIELD

The present invention relates to a black resisct composition for use in producing an optical color filter to be used in color television sets, liquid crystal display devices, solid imaging devices, cameras and the like. More specifically, the invention relates to a black resist composition for color filter, which contains titanium black and carbon black as black pigments and has therefore high light resistance and which is additionally excellent in terms of insulation property, thin line shape and resolution property.

### BACKGROUND ART

Color filter is generally produced by forming a black matrix (black matrix) on the surface of a transparent substrate such as glass and plastic sheet and then sequentially forming different colors of three kinds or more, such as red (R), green (G) and blue (B) in color patterns such as stripe pattern or mosaic pattern. The pattern size varies, depending on the use of the color filter and each color. However, the pattern is generally about 5 to 700 μm. Additionally, the positional precision in overlaying is several μm to several tens μm. Such color filter is produced by microfine fabrication techniques with high dimensional precision.

Typical methods for producing such color filter are for example dyeing method, printing method, pigment dispersion method and electrodeposition method. Among them, particularly, the pigment dispersion method including coating a photosensitive composition containing color materials on a transparent substrate and repeating image exposure, development and curing if necessary to form a color filter image is widely used owing to the high precision in the position of color filter pixels, film thickness and the like, excellent durability such as light resistance and thermal resistance, and less defects of pinhole and the like.

Black matrix is generally arranged in a lattice, stripe or mosaic pattern in between color patterns of R, G and B. Black matrix works for improving contrast owing to the suppression of color mixing of the individual colors or for preventing erroneous motion of thin film transistor (TFT) because of optical leak. Therefore, it is demanded that black matrix should have high light resistance.

Black matrix has generally been formed from a metal film of chromium and the like. Because the approach includes depositing metals such as chromium on a transparent substrate and treating the resulting chromium layer after photolithography process by etching, high light resistance can be obtained from such a thin film thickness at high precision. Nonetheless, the approach requires a long production process at low productivity. The approach has also problems of high cost and environmental pollutions due to liquid waste from the etching process.

Therefore, an approach for forming a non-pollutive black matrix (resin black matrix) from a photosensitive resin with light-resisting pigments dispersed therein at low cost is under active investigation. However, currently, such resin black matrix has many problems as described below.

So as to give light resistance (optical density) at the same level as that of black matrix from metal films of chromium and the like to such resin black matrix, essentially, the content of light-resisting pigments should be higher or the film thickness should be larger.

The method including making the film thickness larger damages the evenness of colored pixels of R, G and B as formed on the black matrix, under the influences of the protrusions and recesses of the black matrix. Therefore, the method causes the ununiformity of liquid crystal cell gap or disorders the orientation of liquid crystal, to cause the deterioration of the display potency. Additionally, the method causes another problem of the occurrence of the burnout of indium tin oxide film as a transparent electrode arranged on color filter.

Because carbon black is dispersed at a high concentration by the method including increasing the content of light-resisting pigments, further, a binding resin should be decreased due to the increase of the dispersion of carbon black at such high concentration, to deteriorate the sensitivity, development property, resolution property, and adhesion of the resulting resist and the like. Additionally because carbon black is conductive despite the high shielding property, disadvantages occur such as conduction between liquid crystal-driving electrodes and drive motion of electric field via black matrix. So as to overcome such disadvantages, a proposition is made to use titanium black as a light-resisting pigment. For example, the official gazette of JP-A-1-141963 discloses a composition of titanium oxynitride. Additionally, the official gazette of JP-A-2001-281440 and the official gazette of JP-A-2001-183510 disclose light-resisting films and color filters using titanium black as a black pigment.

However, these methods are problematic in that the mass ratio of titanium black in the resulting resist solids is higher so as to get light resistance at the same level as that of carbon black.

Additionally, propositions to use carbon black as a light-resisting pigment are made in for example JP-A-4-63879 disclosing a method for forming a black matrix including dispersing carbon black and an organic pigment in a photopolymerization composition and in JP-A-2002-249678 disclosing a method including coating carbon black with a resin to get insulation property.

However, these methods involve the decrease of binding resins as described above to adversely affect the dispersibility, sensitivity, and resolution property of the resulting resist and the like.

### DISCLOSURE OF THE INVENTION

It is an object of the invention to provide a black resist composition for color filter, by which the problems described above can be overcome. Based on the black resist composition, patterns can readily be formed by photolithography. The black resist composition has excellent high light resistance and high insulation property, and can be made into a thin film to give sufficient sensitivity and resolution property.

As a consequence of investigations, the inventors found that a very excellent black resist composition for color filter could be obtained by making a combination of a specific titanium black particle and a specific carbon black particle and additionally using an acrylic copolymer dispersant with an amino group and/or a quaternary ammonium salt. Thus, the invention has been achieved.

Specifically, the invention relates to a black resist composition for color filter, as described below in 1 to 7.
(1) A black resist composition for color filter, the black resist composition containing titanium black (A) with an average primary particle size of 110 nm or less and carbon black (B) with an average primary particle size of 60 nm or less, where the ratio in mass between the titanium black (A) and the titanium black (B) is 100:5 to 1000.
(2) The black resist composition for color filter as described above in 1, where the titanium black (A) is low-level titanium oxide.
(3) A black resist composition for color filter, the black resist composition containing titanium black (A) with an average primary particle size of 110 nm or less, carbon black (B) with an average primary particle size of 60 nm or less, an acrylic copolymer dispersant (C) with an amino group and/or a quaternary ammonium salt and an organic solvent (D).
(4) The black resist composition for color filter as described above in (3), the black resist composition additionally containing a binder resin (E) with a carboxyl group and an ethylenic unsaturated group.
(5) The black resist composition for color filter as described above in (4), where the binder resin (E) is an epoxy(meth)acrylate resin with a carboxyl group.
(6) The black resist composition for color filter as described above in (3), where the acrylic copolymer dispersant (C) with an amino group and/or a quaternary ammonium salt contains a (meth)acrylate-series monomer described below in (i) and/or (ii) as a copolymerization component:
(i) 10 to 85 parts by mass of at least one selected from the group consisting of (meth)acrylate alkyl ester where the alkyl moiety contains an alkyl group with one to 18 carbon atoms, (meth)acrylate ester represented by the following formula (1) 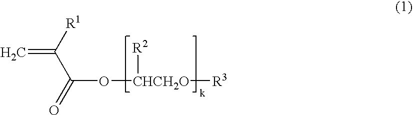
(in the formula, R¹ and R² independently represent a hydrogen atom or a methyl group; R³ represents an alkyl group with one to 18 carbon atoms; and k represents an integer of one to 50), (meth)acrylate ester represented by the following formula (2): 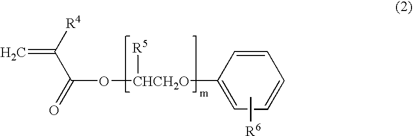
(in the formula, R⁴ and R⁵ independently represent a hydrogen atom or a methyl group; R⁶ represents an alkyl group with one to 18 carbon atoms; and m represents an integer of one to 50), and (meth)acrylate ester with a hydroxyl group to 100 parts by mass of the acrylic copolymer dispersant (C); and
(ii) 15 to 90 parts by mass of an aminoalkyl (meth)acrylate monomer represented by the following formula (3): 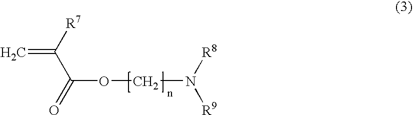
(in the formula, R⁷ represents a hydrogen atom or a methyl group; R¹ and R⁹ independently represent a hydrogen atom or an alkyl group with one to 6 carbon atoms; and n represents an integer of 2 to 8), and/or a quaternary ammonium (meth)acrylate monomer represented by the following formula (4): 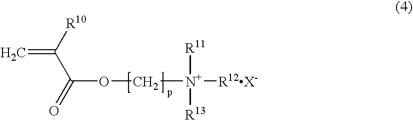
(in the formula, R¹⁰ represents a hydrogen atom or a methyl group; R¹¹, R¹² and R¹³ independently represent an alkyl group with one to 6 carbon atoms, a hydroxyalkyl group with 2 to 6 carbon atoms, an alkoxyalkyl group with one to 4 carbon atoms, a cycloalkyl group, an aralkyl group or a phenyl group which may or may not be substituted; X⁻ represents a halogen anion or an acid anion residue; and p represents an integer of 2 to 8) to 100 parts by mass of the acrylic copolymer dispersant (C).
(7) The black resist composition for color filter as described above in any of (3) to (6), where the ratio in mass of the total of the titanium black as the component (A) and the carbon black as the component (B) to the acrylic copolymer dispersant (C) with an amino group and/or a quaternary ammonium salt is 100:3 to 25.

### DETAILED DESCRIPTION OF THE INVENTION

The invention is now described in detail below. In the following description, the “part” (%) expressing the amount (ratio) is on a mass basis, unless otherwise stated.

Additionally, “(meth)acrylic acid” includes acrylic acid and/or methacrylic acid, while “(meth)acryloyl” includes acryloyl and/or methacryloyl.

The black resist composition for color filter in accordance with the invention characteristically contains the titanium black (A) of an average primary particle size of 100 nm or less and the carbon black (B) of an average primary particle size of 60 nm or less and may additionally contain the acrylic copolymer dispersant (C) with an amino group and/or a quaternary ammonium salt and an organic solvent (D). Further, the black resist composition may contain the binder resin (E) with a carboxyl group and an ethylenic unsaturated group [epoxy(meth)acrylate resin (F) with a carboxyl group, in particular], and may additionally be mixed with an ethylenic unsaturated monomer and a photopolymerization initiator. The ethylenic unsaturated monomer and the photopolymerization initiator may be any such ones with no specific limitation. In some case, a polyfunctional thiol compound with two or more thiol groups may be added.

The titanium black as the component (A) for use in accordance with the invention includes titanium compounds for general use as a black color agent and specifically includes for example low-level titanium oxide (TiO₂₋ₙ, 0<n<2) and titanium oxynitride (TiON). Preferably, the titanium black is low-level titanium oxide.

The average primary particle size of the titanium black (A) in accordance with the invention is essentially 110 nm or less, preferably 100 μm or less, and particularly preferably 80 μm or less. When the average primary particle size exceeds 110 nm, the dispersion stability of the resulting resist composition is deteriorated even when a specific dispersant is used, because titanium black has a large specific gravity.

As the method for producing titanium black, various methods such as reduction with titanium dioxide and metal titanium powder under heating and reduction of titanium dioxide powder in the presence of ammonia under heating. Any such method may be satisfactory with no specific limitation. Specific examples of titanium black include commercially available products such as 13M, 13M-C, and 13R manufactured by Jemco, Inc. and Tilack D manufactured by Ako Kasei Kabushiki Kaisha.

The carbon black for use in accordance with the invention is a black or grayish black powder generated by incomplete combustion or thermal decomposition of organic matters. The principal component thereof is carbon.

The average primary particle size of the carbon black (B) in accordance with the invention is 60 nm or less, preferably 50 nm or less, and more preferably 30 nm or less. When the average primary particle size of the carbon black exceeds 60 nm, unpreferably, the dispersion state is deteriorated, so that the resolution level is lowered.

Further, the average primary particle size is determined by measuring several thousands of the particles on electromicroscopic pictures to calculate the average value.

Additionally, the specific surface area of the carbon black is preferably 40 to 120 BET-m²/g.

The microstate of the carbon black surface varies depending on the method for producing the carbon black. The method for producing the carbon black includes for example channel method, furnace method, thermal method, lamp black method and acetylene method.

Specific examples of the carbonblack include commercially available products such as Raven 1040, Raven 1060, Raven 1080, Raven 1100, and Raven 1255 manufactured by Colombian Carbon Company and Special Black 550, Special Black 350, Special Black 250, and Special Black 100 manufactured by Degussa Ltd.

The mix ratio of the titanium black as the component (A) and the carbon black as the component (B) is preferably 100:5 to 1000, particularly preferably 100:7 to 550 in mass ratio. When the mass ratio of the carbon black is less than 5, the dispersibility is deteriorated because of the difference in specific gravity, so that the titanium black precipitates. When the resulting black resist composition is prepared into a coating film, further, the resulting film is never prepared in a close-packed structure, with the result of no optical density. Alternatively when the mass ratio of the carbon black exceeds 1000, the resulting black resist composition has no insulation property.

Due to the large specific gravity, titanium black can maintain stability with much difficulty, even when a specific dispersant is used. Via the combination of titanium black of a specific particle size and carbon black of a specific particle size, the resulting black resist composition can maintain high dispersibility.

Further, the use of the acrylic copolymer dispersant (C) with an amino group and/or a quaternary ammonium salt makes both the titanium black as the component (A) and the carbon black as the component (B) dispersible, so that a very great black resist composition can be obtained. The reason may possibly be that the titanium black is at pH 6 to 8, depending on the reduction level, so that the titanium black can interact with the dispersant as the component (C).

The optical density of the black resist composition for color filter is practically 3 to 6. The combined use of the titanium black and the carbon black gives a value larger than the optical density of each of the titanium black and the carbon black at their contents. This may be due to the close packing of the titanium black in the carbon black structure.

In accordance with the invention, light-resisting materials other than the titanium black and the carbon black may be used in combination. Such light-resisting materials include for example graphite, carbon nanotube, black iron oxide, an iron oxide-series black pigment, aniline black and cyanine black. Additionally, organic pigments of three colors namely red, green and blue colors may be mixed together and used as a black pigment.

The acrylic copolymer dispersant (C) with an amino group and/or a quaternary ammonium salt for use in accordance with the invention (sometimes referred to as “component (C)” hereinafter) includes a (meth)acrylic copolymer dispersant with a number average molecular weight of 4000 to 100000, comprising at least one (meth)acrylate monomer selected from the group consisting of a (meth)acrylate alkyl ester where the alkyl moiety contains an alkyl group with one to 18 carbon atoms, (meth)acrylate ester represented by the following formula (1): 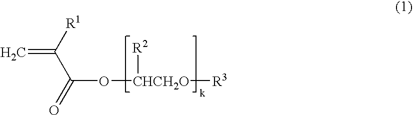
(in the formula, R¹ and R² independently represent a hydrogen atom or a methyl group; R³ represents an alkyl group with one to 18 carbon atoms; and k represents an integer of one to 50), a (meth)acrylate ester represented by the following formula (2): 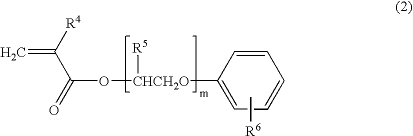
(in the formula, R⁴ and R⁵ independently represent a hydrogen atom or a methyl group; R⁶ represents an alkyl group with one to 18 carbon atoms; and m represents an integer of one to 50), and (meth)acrylate ester with a hydroxyl group, and/or (ii) an aminoalkyl (meth)acrylate monomer represented by the following formula (3): 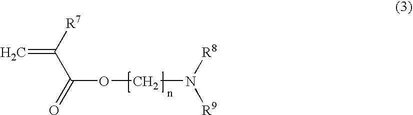
(in the formula, R⁷ represents a hydrogen atom or a methyl group; RB and R⁹ independently represent a hydrogen atom or an alkyl group with one to 6 carbon atoms; and n represents an integer of 2 to 8), and/or a quaternary ammonium (meth)acrylate monomer represented by the following formula (4): 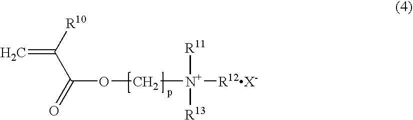
(in the formula, R¹⁰ represents a hydrogen atom or a methyl group; R¹¹, R¹² and R¹³ independently represent an alkyl group with one to 6 carbon atoms, a hydroxyalkyl group with 2 to 6 carbon atoms, an alkoxyalkyl group with one to 4 carbon atoms, a cycloalkyl group, an aralkyl group or a phenyl group which may or may not be substituted; X⁻ represents a halogen anion or an acid anion residue; and p represents an integer of 2 to 8), where 10 to 85 parts by mass of the monomer (i) and/or 15 to 90 parts by mass of the monomer (ii) is contained as a copolymerizable component in 100 parts by mass of the acrylic copolymer dispersant (C).

When the monomer (i) is less than 10 parts by mass, the solubility in an organic solvent and the compatibility of the resist with a binder resin are deteriorated, so that applicable resins are limited. When the monomer (i) exceeds 85 parts by mass, alternatively, the dispersion rate and dispersion stability of the titanium black and the carbon black are deteriorated.

When the monomer (ii) is less than 10 parts by mass, the affinity of the titanium black with the carbon black is so less that the monomer cannot completely be dispersed. When the monomer (ii) exceeds 60 parts by mass, alternatively, the resistance of the cured resist film against alkaline developing solutions is deteriorated.

The monomer (i) is used for the purpose of increasing the solubility in organic solvents and the compatibility with other binder resins. Specific examples of the (meth)acrylate alkyl ester where the alkyl moiety contains an alkyl group with one to 18 carbon atoms include methyl (meth)acrylate, ethyl (meth)acrylate, n-propyl (meth)acrylate, isopropyl (meth)acrylate, n-butyl (meth)acrylate, isobutyl (meth)acrylate, hexyl (meth)acrylate, 2-ethylhexyl (meth)acrylate, isodecyl (meth)acrylate, lauryl (meth)acrylate, and stearyl (meth)acrylate.

Specific examples of the (meth)acrylate ester represented by the formula (1) include methoxydiethylene glycol (meth)acrylate, methoxypolyethylene glycol (meth)acrylate, methoxypropylene glycol (meth)acrylate, methoxydipropylene glycol (meth)acrylate, methoxypolypropylene glycol (meth)acrylate, and n-butoxyethylene glycol (meth)acrylate.

Specific examples of the (meth)acrylate ester represented by the formula (2) include 2-phenoxyethyl (meth)acrylate, phenoxypolyethylene glycol (meth)acrylate, and trioxyethylene nonylphenol (meth)acrylate.

Specific examples of the (meth)acrylate ester with a hydroxyl group include 2-hydroxyethyl (meth)acrylate, 2-hydroxypropyl (meth)acrylate and 2-hydroxybutyl (meth)acrylate.

The monomer (ii) is used for the purpose of forming anionic bond with a carboxyl group on the carbon black surface, for use as an adsorption site onto the titanium black and the carbon black.

Specific examples of the aminoalkyl (meth)acrylate represented by the formula (3) include N,N-dimethylaminoethyl (meth)acrylate, N,N-diethylaminoethyl (meth)acrylate, N-t-butylaminoethyl (meth)acrylate, N,N-dimethylaminopropyl (meth)acrylate, N,N-dimethylaminobutyl (meth)acrylate, N-propylaminoethyl (meth)acrylate and N-butylaminoethyl (meth)acrylate.

The quaternary ammonium (meth)acrylate represented by the formula (4) is a monomer with one quaternary ammonium group and one (meth)acryloyl group within one molecule. Specific examples thereof include (meth)acryloxypropyltrimethylammonium chloride, (meth)acryloxypropyltriethanol ammonium chloride, (meth)acryloxypropyldimethylbenzylammonium chloride and (meth)acryloxypropyldimethylphenylammonium chloride.

X⁻ in the quaternary ammonium (meth)acrylate monomer represented by the formula (4) is not limited to halogen anions such as Cl⁻, Br⁻, I⁻ and F⁻. The monomer may satisfactorily be a monomer containing acid anion residues such as HSO₄⁻, SO₄²⁻, No₃⁻, PO₄³⁻, HPO₄³⁻, H₂PO₄⁻, C₆H₅SO₃⁻, and OH⁻.

The acrylic copolymer dispersant as the component (C) is obtained by general solution polymerization and is specifically produced by using the monomer (i) and/or the monomer (ii), and other monomers if necessary for radical polymerization in an appropriate inactive solvent in the presence of a polymerization initiator.

The weight average molecular weight of the component (C) is preferably 5000 to 200000, more preferably 10000 to 100000 as weight average molecular weight on a polystyrene basis by gel permeation chromatography (sometimes referred to as “GPC” hereinafter).

The organic solvent (D) in accordance with the invention may be any organic solvent capable of dissolving materials to be used, with no specific limitation and includes for example ethers such as diisopropyl ether, ethyl isobutyl ether, and butyl ether; esters such as ethyl acetate, isopropyl acetate, butyl acetate (n, sec, tert), amyl acetate, ethyl 3-ethoxypropionate, methyl 3-methoxypropionate, ethyl 3-methoxypropionate, propyl 3-methoxypropionate, and butyl 3-methoxypropionate; ketones such as methyl ethyl ketone, isobutyl ketone, diisopropyl ketone, ethyl amyl ketone, methyl butyl ketone, methyl hexyl ketone, methyl isoamyl ketone, methyl isobutyl ketone, and cyclohexanone; glycols such as ethylene glycol monomethyl ether, ethylene glycol monoethyl ether, ethylene glycol diethyl ether, ethylene glycol monomethyl ether acetate, ethylene glycol monoethyl ether acetate, diethylene glycol monoethyl ether acetate, propylene glycol mono-t-butyl ether, propylene glycol monomethyl ether, propylene glycol monoethyl ether, propylene glycol monomethyl ether acetate, propylene glycol monoethyl ether acetate, dipropylene glycol monoethyl ether, dipropylene glycol monomethyl ether, dipropylene glycol monomethyl ether acetate, dipropylene glycol monoethyl ether acetate, ethylene glycol monobutyl ether, and tripropylene glycol methyl ether.

The organic solvent as the component (D) preferably can dissolve or disperse other individual components and has a boiling point of 100 to 200° C. More preferably, the organic solvent has a boiling point of 120 to 170° C. These organic solvents may be used singly or in combination of two or more thereof.

In accordance with the invention, the binder resin (E) (sometimes referred to as “binder resin” hereinbelow) with a carboxyl group and an ethylenic unsaturated group is a component mainly determining various characteristic properties such as resist film strength, thermal resistance, substrate adhesion, and solubility in aqueous alkali solution (alkali-developing property). Any such binder resin capable of satisfying the required characteristic properties can appropriately be used. Such binder resin as the component (E) includes for example acryl copolymer, epoxy(meth)acrylate resin, and urethane (meth)acrylate resin.

The acryl copolymer with a carboxyl group and an ethylenic unsaturated group can be obtained by copolymerizing together the ethylene unsaturated group (a) containing a carboxyl group and an ethylenic unsaturated group (b) except (a). So as to further enhance photosensitivity, some carboxyl groups in the side chains of the acryl copolymer obtained by copolymerizing together the monomers may be allowed to react with the epoxy group in a compound with an epoxy group and an ethylenic unsaturated group within one molecule, to give an ethylenic unsaturated group to the side chains.

Specific examples of the compound with an epoxy group and an ethylenic unsaturated group within one molecule include glycidyl (meth)acrylate, 3,4-epoxycyclohexylmethyl (meth)acrylate, 4-(2,3-epoxypropoxy)butyl (meth)acrylate, allylglycidyl ether, and 4-hydroxybutyl acrylate glycidyl ether. Among them, glycidyl (meth)acrylate and 4-hydroxybutyl acrylate glycidyl ether are preferable from the respect of ready availability and the improvement of curability.

The isocyanate group in a compound with an isocyanate group and an ethylenic unsaturated group within one molecule is allowed to react with a part or the entirety of the hydroxyl groups in the acryl copolymer, to give the ethylenic unsaturated group to the side chains. Specific examples of the compound with an isocyanate group and an ethylenic unsaturated group within one molecule include 2-methacryloyloxy ethyl isocyanate.

The ethylenic unsaturated monomer (a) containing a carboxyl group is used for the purpose of giving alkali-developing property to the acryl copolymer.

Specific examples of the ethylenicunsaturatedmonomer (a) containing a carboxyl group include unsaturated monocarboxylic acids such as (meth)acrylic acid, crotonic acid, α-chloroacrylic acid, ethylacrylic acid and cinnamic acid; unsaturated dicarboxylic acids (anhydrides) such as 2-(meth)acryloyloxyethylsuccinic acid, 2-(meth)acryloyloxyethylphthalic acid, (meth)acryloyloxyethylhexahydrophthalic acid, maleic acid, maleic anhydride, fumaric acid, itaconic acid, and itaconic anhydride; or unsaturated carboxylic acids (anhydrides) of trivalence or a larger valence. Among them, (meth)acrylic acid is preferable.

The ethylenic unsaturated monomer (b) except the ethylenic unsaturated monomer (a) containing a carboxyl group is used for the purpose of controlling film strength and pigment dispersibility. Specific examples thereof include vinyl compounds such as styrene, α-methylstyrene, (o, m, p-)hydroxystyrene, and vinyl acetate; (meth)acrylates such as methyl (meth)acrylate, ethyl (meth)acrylate, n-propyl (meth)acrylate, isopropyl (meth)acrylate, n-butyl (meth)acrylate, tert-butyl (meth)acrylate, n-hexyl (meth)acrylate, cyclohexyl (meth)acrylate, benzyl (meth)acrylate, phenoxyethyl (meth)acrylate, isobornyl (meth)acrylate, tetrahydrofurfuryl (meth)acrylate, (meth)acrylonitrile, glycidyl (meth)acrylate, allylglycidyl ether, 2-hydroxyethyl (meth)acrylate, 2-hydroxypropyl (meth)acrylate, N,N-dimethylaminoethyl (meth)acrylate, trifluoroethyl acrylate, 2,2,3,3-tetrafluoropropyl (meth)acrylate, and perfluorooctylethyl (meth)acrylate; and compounds with an amide group, such as (meth)acrylamide, N,N-dimethyl (meth)acrylamide, N,N-diethyl (meth)acrylamide, N-methyl (meth)acrylamide, N-ethyl (meth)acrylamide, N-isopropyl (meth)acrylamide, N-vinylpyrrolidone, N-vinylcaprolactam, and N-(meth)acryloyl morpholine.

The copolymerization ratio in mass ratio between the ethylenic unsaturated monomer (a) containing a carboxyl group and the ethylenic unsaturated monomer (b) except (a) is preferably 5:95 to 40:60, more preferably 10:90 to 50:50. When the copolymerization ratio of the monomer (a) is less than 5, the alkali-developing property is deteriorated, so that any pattern is formed with much difficulty. When the copolymerization ratio of the monomer (a) exceeds 60, alternatively, the alkali development of optically cured parts more readily progresses, so that the line width is constantly maintained with much difficulty.

The molecular weight of the acryl copolymer with a carboxyl group and the ethylenic unsaturated group is preferably 1,000 to 500,000, more preferably 3,000 to 200,000 as weight average molecular weight on a polystyrene basis by GPC. When the weight average molecular weight is less than 1,000, the film strength is significantly decreased. When the weight average molecular weight exceeds 500,000, the alkali-developing property is prominently deteriorated.

The acryl copolymer may be used singly or in combination of two types or more thereof in mixture.

As the epoxy(meth)acrylate with a carboxyl group in accordance with the invention, epoxy(meth)acrylate obtained by the reaction of a reaction product from an epoxy compound and an unsaturated group-containing monocarboxylic acid with an acid anhydride may be used, with no specific limitation.

The epoxy compound includes for example but is not limited to epoxy compounds such as bisphenol A type epoxy compounds, bisphenol F type epoxy compounds, bisphenol S type epoxy compounds, phenol Novolak type epoxy compounds, cresol Novolak type epoxy compounds or aliphatic epoxy compounds. These may be used singly or in combination of two or more thereof.

The unsaturated group-containing monocarboxylic acid includes for example (meth)acrylic acid, 2-(meth)acryloyloxyethylsuccinic acid, 2-(meth)acryloyloxyethylphthalic acid, (meth)acryloyloxyethylhexahydrophthalic acid, (meth)acrylic acid dimer, β-furfurylacrylic acid, β-styrylacrylic acid, cinnamic acid, crotonic acid, and α-cyanocinnamic acid. Furthermore, the unsaturated group-containing monocarboxylic acid additionally includes semi-ester compounds as products from the reaction of hydroxyl group-containing acrylate with saturated or unsaturated dibasic anhydride, and semi-ester compounds as products from the reaction of unsaturated group-containing monoglycidyl ether with saturated or unsaturated dibasic anhydride. These unsaturated group-containing monocarboxylic acid may be used singly or in combination of two or more thereof.

The acid anhydride includes for example dibasic acid anhydrides such as maleic anhydride, succinic anhydride, itaconic anhydride, phthalic anhydride, tetrahydrophthalic anhydride, hexahydrophthalic anhydride, methylhexahydrophthalic anhydride, endomethylene tetrahydrophthalic anhydride, methylendomethylene tetrahydrophthalic anhydride, chlorendic anhydride, and methyltetrahydrophthalic anhydride; aromatic polyhydric carboxylic anhydrides such as trimellitic anhydride, pyromellitic anhydride, and benzophenone tetracarboxylic dianhydride; and polyhydric carboxylic anhydride derivatives such as 5-(2,5-dioxotetrahydrofuryl)-3-methyl-3-cyclohexene-1,2-dicarboxylic anhydride, and endobicyclo-[2,2,1]-hept-5-ene-2,3-dicarboxylic anhydride. These may be used singly or in combination of two or more thereof.

With no specific limitation, the molecular weight of the epoxy(meth)acrylate with a carboxyl group is preferably 1,000 to 40,000, more preferably 2,000 to 5,000 as weight average molecular weight on a polystyrene basis by GPC.

The acid vale (meaning acid value of solids; measured according to JISK0070) of the epoxy(meth)acrylate is preferably 10 mg KOH/g or more, more preferably 45 to 160 mg KOH/g, still more preferably 50 to 140 mg KOH/g because the alkali solubility and the alkali resistance of the resulting cured film are well balanced at the acid value. When the acid value is less than 10 mg KOH/g, alkali solubility is deteriorated. When the acid value is so large to exceed 160 mg KOH/g, adversely, such acid value may sometimes be a factor to deteriorate characteristic properties such as alkali resistance of the resulting cured film, which depends on the combination of components composing the black resist composition.

The urethane (meth)acrylate resin with a carboxyl group in accordance with the invention is a binder resin softer than the acryl copolymer and the epoxy(meth)acrylate, and is used for applications requiring softness and bending resistance.

The urethane (meth)acrylate resin with a carboxyl group is a resin containing a unit derived from (meth)acrylate with a hydroxyl group, a unit from polyol, and a unit from polyisocyanateas the constitutional units. More specifically, the urethane (meth)acrylate comprises a (meth)acrylate-derived unit with hydroxyl groups at both the ends, where the part between both the ends comprises a repeat unit comprising a polyol-derived unit and a polyisocyanate-derived unit, where both the units are bound together via urethane bond. In the repeat unit, a carboxyl group exists structurally.

The urethane (meth)acrylate compound with a carboxyl group is in a structure comprising a repeat unit represented by the formula:
-(OrbO-OCNHRcNHCO)n-
(in the formula, ORbO represents the dehydrogenized residue of polyol; Rc represents the deisocyanated residue of polyisocyanate; and n is an integer expressing the number of the repeat unit).

The urethane (meth)acrylate resin with a carboxyl group can be produced by reaction of at least (meth)acrylate with a hydroxyl group, polyol, and polyisocyanate. A compound with a carboxyl group is necessarily used as at least one of polyol or polyisocyanate. Preferably, polyol with a carboxyl group is used. As described above, the use of a compound with a carboxyl group as polyol and/or polyisocyanate enables the production of urethane (meth)acrylate with a carboxyl group in Rb or Rc. Herein, n is preferably about 1 to 200, more preferably 2 to 30 in the formula. When n is within such range, the flexibility of the resulting cured film is higher.

In case that two types or more of at least one of polyol and polyisocyanate are used, the repeat unit comprises plural types. As to the regularity of the plural units, complete random, block or localization is appropriately selected, depending on the purpose.

The (meth)acrylate with a hydroxyl group includes for example 2-hydroxyethyl(meth)acrylate, hydroxypropyl(meth)acrylate, hydroxybutyl(meth)acrylate, and caprolactone or alkylene oxide adducts of the individual (meth)acrylates described above, glycerin mono(meth)acrylate, glycerin di(meth)acrylate, glycidyl methacrylate-acrylic acid adduct, trimethylolpropane mono(meth)acrylate, trimethylol di(meth)acrylate, pentaerythritol tri(meth)acrylate, dipentaerythritol penta(meth)acrylate, and trimethylolpropane-alkylene oxide adduct-di(meth)acrylate. Among them, 2-hydroxyethyl(meth)acrylate, hydroxypropyl(meth)acrylate and hydroxybutyl(meth)acrylate are preferable. Particularly, 2-hydroxyethyl(meth)acrylate is preferable because the acrylate enables ready synthesis of urethane (meth)acrylate resin.

These (meth)acrylates with a hydroxyl group may be used singly or in combination of two or more thereof.

As the polyol for use in accordance with the invention, polymer polyol and/or dihydroxyl compound can be used. Polymer polyol includes for example polyether-series diol such as polyethylene glycol, polypropylene glycol, and polytetramethylene glycol; polyester-series polyol obtained from esters of polyhydric alcohol and polybasic acid; polycarbonate-series diol containing a unit derived from hexamethylene carbonate and pentamethylene carbonate as the structural unit, and polylactone-series diol such as polycaprolactone diol and polybutyrolactone diol.

In case that polymer polyol with a carboxyl group is used, for example a compound synthetically prepared by allowing a polybasic acid of trivalence or a larger valence such as trimellitic acid (anhydride) to exist concurrently during the synthesis of the polymer polyol to leave the carboxyl group as it is can be used.

These polymer polyols may be used singly or in combination of two or more thereof. When a polymer polyol with a number average molecular weight of 200 to 2,000 is used as such polymer polyol, the flexibility of the resulting cured film is higher.

As the dihydroxyl compound, a branched or linear compound with two alcoholic hydroxyl groups can be used. Dihydroxy aliphatic carboxylic acid with a carboxyl group is particularly preferably used. Such dihydroxyl compound includes for example dimethylol propionic acid and dimethylol butanoic acid. The use of such dihydroxy aliphatic carboxylic acid with a carboxyl group readily allows the presence of a carboxyl group in the resulting urethane (meth)acrylate compound. Dihydroxyl compounds may be used singly or in combination of two or more thereof and may be used in combination with polymer polyol.

In case that polymer polyol with a carboxyl group is used in combination or that the polyisocyanate with a carboxyl group as described below is used as the polyisocyanate described below, dihydroxyl compounds without a carboxyl group may satisfactorily be used, such as ethylene glycol, diethylene glycol, propylene glycol, 1,4-butanediol, 1,3-butanediol, 1,5-pentanediol, neopentyl glycol, 3-methyl-1,5-pentanediol, 1,6-hexanediol, and 1,4-cyclohexane dimethanol.

Polyisocyanate for use in accordance with the invention specifically includes for example 2,4-toluene diisocyanate, 2,6-toluene diisocyanate, isophorone diisocyanate, hexamethylenediisocyanate, diphenylmethylenediisocyanate, (o, m, p)-xylene diisocyanate, methylenebis(cyclohexylisocyanate), trimethylhexamethylene diisocyanate, cyclohexane-1,3-dimethylene diisocyanate, cyclohexane-1,4-dimethylene diisocyanate and 1,5-naphthalene diisocyanate. These polyisocyanates may be used singly or in combination of two or more thereof. Additionally, polyisocyanate with a carboxyl group may also be used.

The molecular weight of the urethane (meth)acrylate resin with a carboxyl group for use in accordance with the invention is without any specific limitation. However, the weight average molecular weight thereof on a polystyrene basis by GPC is 1,000 to 40,000, more preferably 8,000 to 30,000. When the number average molecular weight is less than 1,000, the extension and strength of the cured film may sometimes be deteriorated. When the number average molecular weight exceeds 40,000, the resulting cured film may be harder, so that the flexibility thereof may be deteriorated.

The acid value of the urethane (meth)acrylate resin is preferably 5 to 150 mg KOH/g, more preferably 30 to 120 mg KOH/g. When the acid value is less than 5 mg KOH/g, the alkali solubility of the resulting black resist composition may sometimes be deteriorated. When the acid value exceeds 150 mg KOH/g, the alkali resistance of the cured film may sometimes be deteriorated.

The ethylenic unsaturated monomer for use in the resist composition of the invention is blended for the purpose of making an exposed part insoluble in an alkaline developing solution after polymerization and crosslinking with radicals generated from a photopolymerization initiator at the time of photoirradiation.

As the ethylenic unsaturated monomer, (meth)acrylate ester is preferable. Specific examples thereof include alkyl (meth)acrylates such as methyl (meth)acrylate, ethyl (meth)acrylate, propyl (meth)acrylate, butyl (meth)acrylate, isobutyl (meth)acrylate, sec-butyl (meth)acrylate, tert-butyl (meth)acrylate, hexyl (meth)acrylate, octyl (meth)acrylate, isooctyl (meth)acrylate, 2-ethylhexyl (meth)acrylate, decyl (meth)acrylate, lauryl (meth)acrylate, and stearyl (meth)acrylate; alicyclic (meth)acrylates such as cyclohexyl (meth)acrylate, isobornyl (meth)acrylate, dicyclopentenyl (meth)acrylate, and dicyclopentenyloxyethyl (meth)acrylate; aromatic (meth)acrylates such as benzyl (meth)acrylate, phenyl (meth)acrylate, phenylcarbitol (meth)acrylate, nonylphenyl (meth)acrylate, (meth)acrylate, nonylphenylcarbitol (meth)acrylate, and nonylphenyl(meth)acrylate; (meth)acrylates with a hydroxyl group, such as 2-hydroxyethyl (meth)acrylate, hydroxypropyl (meth)acrylate, hydroxybutyl (meth)acrylate, butanediol mono(meth)acrylate, glycerol (meth)acrylate, polyethylene glycol (meth)acrylate or glycerol di(meth)acrylate; (meth)acrylates with an amino group, such as 2-dimethylaminoethyl (meth)acrylate, 2-diethylaminoethyl (meth)acrylate, and 2-tert-butylaminoethyl (meth)acrylate; methacrylates with phosphorous atom, such as methacryloxyethyl phosphate, bis.methacryloxyethyl phosphate, methacryloxyethylphenyl acid phosphate (phenyl P); di(meth)acrylates such as ethylene glycol di(meth)acrylate, diethylene glycol di(meth)acrylate, triethylene glycol di(meth)acrylate, tetraethylene glycol di(meth)acrylate, polyethylene glycol di(meth)acrylate, propylene glycol di(meth)acrylate, dipropylene glycol di(meth)acrylate, tripropylene glycol di(meth)acrylate, 1,4-butandiol di(meth)acrylate, 1,3-butanediol di(meth)acrylate, neopentyl glycol di(meth)acrylate, and 1,6-hexanediol di(meth)acrylate; polyacrylates such as trimethylolpropane tri(meth)acrylate, pentaerythritol tri(meth)acrylate, and dipentaerythritol hexa(meth)acrylate; modified polyol polyacrylates such as bisphenol S diacrylate with added 4 moles of ethylene oxide, bisphenol A diacrylate with added 4 moles of ethylene oxide, aliphatic acid-modified pentaerythritol diacrylate, trimethylol propane triacrylate with added 3 moles of propylene oxide and trimethylol propane triacrylate with added 6 moles of propylene oxide; polyacrylates with isocyanuric acid backbone, such as bis(acryloyloxyethyl)monohydroxyethyl isocyanurate, tris(acryloyloxyethyl)isocyanurate, and ε-caprolactone-added tris(acryloxyethyl)isocyanurate; polyester acrylates such as α, ω-diacryloyl-(bisethylene glycol)-phthalate, and α, ω-tetraacryloyl-(bistrimethylolpropane)-tetrahydrophthalate; glycidyl (meth)acrylate; allyl (meth)acrylate; ω-hydroxyhexanoyloxyethyl (meth)acrylate; polycaprolactone (meth)acrylate; (meth)acryloyloxyethyl phthalate; (meth)acryloyloxyethyl succinate; 2-hydroxy-3-phenoxypropyl acrylate; and phenoxyethyl acrylate. Additionally, N-vinyl compounds such as N-vinylpyrrolidone, N-vinylformamide, and N-vinylacetamide can also be used as the monomer.

Among them, poly(meth)acrylates such as trimethylolpropane tri(meth)acrylate, pentaerythritol tri(meth)acrylate, and dipentaerythritol hexa(meth)acrylate are also preferable because the photosensitivity is higher.

As the photopolymerization initiator for use in accordance with the invention, a compound excited with active ray to generate radicals to initiate the polymerization of the ethylenic unsaturated bond may be used singly or in combination with an enhancer thereof. Because it is required to generate radicals in high light shielding, a photopolymerization initiator with high photosensitivity is used. Such photopolymerization initiator includes for example hexa-aryl biimidazole-series compounds and aminoacetophenone-series compounds.

Specific examples of hexa-arylbiimidazole-series compounds include 2,2′-bis(o-chlorophenyl)-4,4′,5,5′-tetraphenyl-1,2′biimidazole, 2,2′-bis(o-bromophenyl)-4,4′, 5,5′-tetraphenyl-1,2′biimidazole, 2,2′-bis(o-fluorophenyl)-4,4′, 5,5′-tetraphenyl-1,2′biimidazole, and 2,2′-bis(o,p-dichlorophenyl)-4,4′, 5,5′-tetraphenyl-1,2′-biimidazole. A hexa-aryl biimidazole compound represented by the following formula (5): 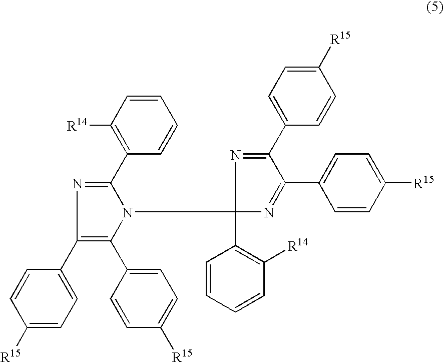
(in the formula, R¹⁴ represents a halogen atom; and R¹⁵ represents an alkyl group with one to 4 carbon atoms, which may or may not have a substituent) is preferable in that because thermally decomposed products generated during the post-bake of the resulting resist are poorly subliming, crystals are hardly deposited onto exhaust vent. Among the hexa-aryl biimidazole compounds represented by the formula (5), 2,2′-bis(2-chlorophenyl)-4,4′-5,5′-tetrakis(4-methylphenyl)-1,2′-biimidazole is particularly preferable.

Specific examples of the aminoacetophenone-series compounds are 2-methyl-1-[4-(methylthio)phenyl]-2-morpholinopropan-1-one and 2-benzyl-2-dimethylamino-1-(4-morpholinophenyl)-butanone-1.

So as to further enhance the sensitivity in accordance with the invention, an enhancer may additionally be blended. Specific examples of such enhancer include benzophenone-series compounds such as benzophenone, 2,4,6-trimethylbenzophenone, 4-phenylbenzophenone, 4-benzoyl-4′-methyldiphenyl sulfide, 4,4′-bis(dimethylamino)benzophenone, and 4,4′-bis(diethylamino)benzophenone; thioxanthone-series compounds such as thioxanthone, 2-methylthioxanthone, 2,4-dimethylthioxanthone, 2,4-diethylthioxanthone, isopropylthioxanthone, 2,4-diisopropylthioxanthone, and 2-chlorothioxanthone; and ketocoumarin-series compounds such as 3-acetylcoumarin, 3-acetyl-7-diethylaminocoumarin, 3-benzoylcoumarin, 3-benzoyl-7-diethylaminocoumarin, 3-benzoyl-7-methoxycoumarin, 3,3′-carbonylbiscoumarin, 3,3′-carbonylbis(7-methoxycoumarin), and 3,3′-carbonylbis(5,7-dimethoxycoumarin).

In accordance with the invention, photopolymerization initiator series except those described above may satisfactorily be used. Examples of other photopolymerization initiator series to be possibly used in accordance with the invention include the combination of the enhancers and the organic boronate-series compounds as described in the official gazette of JP-A-2000-249822 and the like, the titanocene-series compounds described in the official gazettes of JP-A-4-221958, JP-A-4-21975 and the like, and the triazine-series compounds described in the official gazette of JP-A-10-253815 and the like.

In accordance with the invention, a polyfunctional thiol compound with two or more mercapto groups within the molecule may additionally be used as a chain transfer agent in a part of the photopolymerization initiator. The addition of the polyfunctional thiol suppresses the polymerization inhibition with oxygen, to incur the photo-setting reaction even in high light shielding. Specific examples of the polyfunctional thiol compound to be used include hexanedithiol, decanedithiol, 1,4-butanediol bis(3-mercaptopropionate), 1,4-butanediol bis(mercaptoacetate), ethylene glycol bis(mercaptoacetate), ethylene glycol bis(3-mercaptopropionate), trimethylolpropane tris(mercaptoacetate), trimethylolpropane tris(3-mercaptopropionate), pentaerythritol tetrakis(mercaptoacetate), pentaerythritol tetrakis(3-mercaptopropionate) and a polyfunctional thiol compound with a thiol structure as represented by the following formula (6):
—(CH₂)ⱼC(R¹⁶)(R¹⁷)(CH₂)ₕSH (6)
(in the formula, R¹⁶ and R¹⁷ independently represent a hydrogen atom or an alkyl group with one to 10 carbon atoms, where at least one of them is an alkyl group; j represents an integer of 0 to 2; and h represents an integer of 0 or 1).

Among them, a polyfunctional thiol compound with a thiol structure as represented by the formula (6) is preferable from the respect of stability under storage.

Specific examples of the polyfunctional compound with a thiol structure as represented by the formula (6) include ethylene glycol bis(3-mercaptobutylate), 1,2-propylene glycol bis(3-mercaptobutylate), diethylene glycol bis(3-mercaptobutylate), 1,4-butanediol bis(3-mercaptobutylate), 1,8-octanediol bis(3-mercaptobutylate), trimethylolpropane tris (3-mercaptobutylate), pentaerythritol tetrakis(3-mercaptobutylate), dipentaerythritol hexakis (3-mercaptobutylate), ethylene glycol bis(2-mercaptopropionate), 1,2-propylene glycol bis(2-mercaptopropionate), diethylene glycol bis(2-mercaptopropionate), 1,4-butanediol bis(2-mercaptopropionate), 1,8-octanediol bis(2-mercaptopropionate), trimethylolpropane tris (2-mercaptopropionate), pentaerythritol tetrakis(2-mercaptopropionate), dipentaerythritol hexakis (2-mercaptopropionate), ethylene glycol bis(3-mercaptoisobutylate), 1,2-propylene glycol bis(3-mercaptoisobutylate), diethylene glycol bis(3-mercaptoisobutylate), 1,4-butanediol bis(3-mercaptoisobutylate), 1,8-octanediol bis(3-mercaptoisobutylate), trimethylolpropane tris (3-mercaptoisobutylate) (abbreviated as “TPMB” hereinbelow), pentaerythritol tetrakis(3-mercaptoisobutylate), dipentaerythritol hexakis(3-mercaptoisobutylate), ethylene glycol bis(2-mercaptoisobutylate), 1,2-propylene glycol bis(2-mercaptoisobutylate), diethylene glycol bis(2-mercaptoisobutylate), 1,4-butanediol bis(2-mercaptoisobutylate), 1,8-octanediol bis(2-mercaptoisobutylate), trimethylolpropane tris (2-mercaptoisobutylate), pentaerythritol tetrakis(2-mercaptoisobutylate), and dipentaerythritol hexakis(2-mercaptoisobutylate).

The contents of the individual components except the organic solvent as the component (D) in the black resist composition in accordance with the invention are as follows.

The titanium black as the component (A) is preferably at 5 to 80% by mass, more preferably 10 to 60% by mass. When the component (A) is at less than 5% by mass, insulation property cannot be obtained. When the component (A) exceeds 80% by mass, the dispersion stability is deteriorated, so that the black resist composition precipitates or the surface smoothness and linearity thereof are deteriorated.

Furthermore, the carbon black as the component (B) is preferably at 5 to 60% by mass, more preferably 10 to 50% by mass. When the component (B) is at less than 5% by mass, the required light resistance cannot be obtained. When the component (B) exceeds 60% by mass, the surface resistance is observed to be decreased.

The dispersant as the component (C) is preferably at 4 to 15% by mass, more preferably 6 to 12% by mass. When the component (C) is at less than 4% by mass, the components (A) and (B) cannot get sufficient dispersion stability. When the component (C) exceeds 15% by mass, the amounts of the binder resin and the ethylenic unsaturated monomer to be blended should be decreased, so that the photosensitivity is deteriorated while the physical properties of the resulting resist film are deteriorated.

The binder resin as the component (E) is preferably at 10 to 40% by mass, more preferably 12 to 30% by mass. When the component (E) is at less than 10% by mass, the durability of the resist film is deteriorated. Alternatively when the binder resin exceeds 40% by mass, the resist film cannot get sufficient light resistance.

The ethylenic unsaturated monomer is preferably at 3 to 20% by mass, more preferably 5 to 15% by mass. When the ethylenic unsaturated monomer is at less than 3% by mass, sufficient photosensitivity cannot be obtained. When the monomer exceeds 20% by mass, sufficient photosensitivity cannot be obtained.

The photopolymerization initiator is preferably at 2 to 15% by mass, more preferably 5 to 12% by mass. When the photopolymerization initiator is at less than 2% by mass, sufficient photosensitivity cannot be obtained. When the initiator exceeds 15% by mass, the endurable photosensitivity of the resist film cannot be obtained.

The polyfunctional thiol compound is preferably at 2 to 15% by mass, more preferably 5 to 12% by mass. When the polyfunctional thiol compound is at less than 2% by mass, sufficient photosensitivity cannot be obtained. When the polyfunctional thiol compound exceeds 15% by mass, the resulting thin line is wider than the width of the photomask.

In accordance with the invention, additionally, adhesion-improving agents, leveling agents, development-improving agents, antioxidants, thermal polymerization prohibitors and the like may preferably be added other than the ingredients described above.

In accordance with the invention, preferably, the titanium black as the component (A), the carbon black as the component (B), the dispersant as the component (C), the organic solvent as the component (D) and/or the binder resin as the component (E) [the epoxy(meth)acrylate resin with a carboxyl group as the component (F), in particular] are preliminarily blended together, and pre-mixed together with a disperser and the like; and subsequently, the resulting mixture is pulverized and dispersed with roll mills such as twin-roll mill and triple roll mill, ball mills such as ball mill and vibration mill, paint conditioner, and bead mills such as continuous disk type bead mill and continuous annular type bead mill, to obtain a dispersion solution of the titanium black and the carbon black. Among them, continuous annular type bead mill is particularly preferable because the bead mill can pulverize and disperse the mixture for a short time and can make a sharp distribution of particle size after dispersion and additionally because the bead mill can control the temperature during pulverization and dispersion in a ready manner and can suppress the modification of the dispersion solution.

In accordance with the invention, further, a dispersion solution of the titanium black as the component (A) and a dispersion solution of the carbon black as the component (B) may separately be dispersed. A dispersion solution prepared by preliminarily blending and pre-mixing together the titanium black as the component (A), the dispersant as the component (C), the organic solvent as the component (D) and/or the binder resin as the component (E) with a disperser and the like and subsequently pulverizing and dispersing the resulting mixture in the same manner as described above may satisfactorily be mixed with a dispersion solution prepared by preliminarily blending and pre-mixing together the carbon black as the component (B), the dispersant as the component (C), the organic solvent as the component (D) and/or the binder resin as the component (E) with a disperser and the like and subsequently pulverizing and dispersing the resulting mixture in the same manner as described above, so that the same performance can be obtained.

The continuous annular type bead mill is of a structure of a vessel (cylinder) with an inlet and an outlet for materials, where a rotor (rotation body) with a groove for agitating bead is inserted. In a gap of the double cylinder comprising the vessel and the rotor, the rotation of the rotor drives the motion of beads for pulverization, shearing and grinding, to highly efficiently pulverize and disperse the titanium black and the carbon black. A sample is charged from the end of the vessel to be prepared into a microfine particle, which is then discharged from the opposite end of the inlet. The process is repeated until a necessary particle distribution can be obtained. The time period of substantial pulverization and dispersion process of a sample in the vessel is referred to as retention time.

Specific examples of the continuous annular type bead mill include Spike Mill (under trade name) manufactured by Inoue Seisakusho Kabushiki Kaisha and OB-Mill (under trade name) manufactured by Turbo Industry Kabushiki Kaisha.

Preferable conditions for dispersion with the continuous annular type bead mill are as follows. The bead size (diameter) to be used is preferably 0.2 to 1.5 mm, more preferably 0.4 to 1.0 mm. When the bead size is less than 0.2 mm, the weight of one such bead is too small, so that the pulverization energy of one such bead is so small that pulverization never progresses. When the bead size exceeds 1.5 mm, the number of collision of such beads is so small that pulverization can be done for a short period with much difficulty.

From the respect of pulverization efficiency, the material of the bead preferably has a specific gravity of 4 or more and includes for example ceramics of zirconia and alumina and stainless steel.

The peripheral velocity of the rotor is preferably 5 to 20 m/s, more preferably 8 to 15 m/s. When the peripheral velocity is less than 5 m/s, pulverization and dispersion cannot sufficiently be done. When the peripheral velocity exceeds 20 m/s, alternatively, the temperature of the resulting dispersion solution is unpreferably too high via abrasion heat, so that modifications such as viscosity increase occur.

The temperature during dispersion is preferably 10 to 60° C., more preferably ambient temperature to 50° C. When the temperature is less than 10° C., unpreferably, atmospheric moisture is mixed into the resulting dispersion solution due to condensation. When the temperature exceeds 60° C., alternatively, modifications such as the viscosity increase of the resulting dispersion solution occur unpreferably.

The retention time is preferably one to 30 minutes, more preferably 3 to 20 minutes. When the retention time is less than one minute, the pulverization and dispersion process insufficiently progresses. When the retention time exceeds 30 minutes, the resulting dispersion solution is modified, with the resultant increase of the viscosity.

So as to produce the black resist composition in accordance with the invention, the dispersion solution of the titanium black and the carbon black as obtained by the dispersion process is added to and mixed with the ingredients required for the black resist composition, to prepare a homogenous solution. Because fine contaminants are frequently mixed into sensitizing solutions at the production process, the black resist composition is preferably filtered through filter and the like.

With respect to a method for producing a color filter using the black resist composition of the invention, a color filter for liquid crystal display device is now exemplified and described, which is prepared by overlaying the black resist composition, a pigment and a protective film in this order.

The black resist composition of the invention is coated on a transparent substrate. After the solvent is then dried in an oven and the like, the resulting film is exposed through a photomask, to form a black matrix pattern. Then, the pattern is post-baked to completely prepare a black matrix.

Any transparent substrate may be used with no specific limitation. As such, for example, inorganic glasses such as quartz glass, borosilicate glass, and lime soda glass with a silica-coated surface; and films or sheets of polyesters such as polyethylene terephthalate and polyolefins such as polypropylene and polyethylene; thermoplastic plastics such as polycarbonate, polymethyl methacrylate and polysulfone; and thermosetting plastics such as epoxy resin and polyester resin are preferably used. For the purpose of improving the physical properties such as surface adhesion of such transparent substrate, preliminarily, the transparent substrate may be treated with corona discharge process, ozone treatment, and filming process with various polymers such as silane coupling agents and urethane polymer.

The coating method includes for example dip coating, and coating with roll coater, wire bar, flow coater, and die coater and spray coating. Additionally, rotation coating methods with spinner and the like are preferably used.

The solvent is dried with drying apparatuses such as hot plate, an IR oven and a convection oven. Preferable drying conditions are at room temperature to 150° C. for a drying period of 10 seconds to 60 minutes. Additionally, the solvent may be dried in vacuum state.

Concerning the exposure method, a space (gap) of 50 to 200 μm is arranged on the sample, on which a photomask is then placed. Through the photomask, imaging and exposure are done. The light source for use in the exposure includes for example lamp sources such as xenon lamp, high-pressure mercury lamp, ultra-high-pressure mercury lamp, metal halide lamp, medium-pressure mercury lamp, and low-pressure mercury lamp; and laser sources such as argon ion laser, YAG laser, excimer laser, and nitrogen laser. In case that a specific wavelength of an irradiation ray is singly used, an optical filter may be used.

The development process is done by using a developing solution for resist development by dip, shower and puddle methods and the like. As the developing solution, any solvent with an ability to dissolve the resist film on an unexposed part may be satisfactory with no specific limitation. However, an alkali-developing solution is preferable. The alkali-developing solution includes aqueous solutions containing for example inorganic alkali agents such as sodium carbonate, potassium carbonate, sodium silicate, potassium silicate, sodium hydroxide and potassium hydroxide; or organic alkali agents such as diethanolamine, triethanolamine and tetraalkylammonium hydroxide. If necessary, surfactants, aqueous organic solvents, low-molecular compounds with a hydroxyl group or a carboxyl group may be contained in the alkali-developing solution. Surfactants are particularly preferably added because many surfactants have an improving effect on developing property, resolution property, base stain and the like. Examples of the surfactants include anionic surfactants with a sodium naphthalenesulfonate group and a sodium benzenesulfonate group, nonionic surfactants with a polyalkyleneoxy group, cationic surfactants with a tetraalkylammonium group and the like. In some case, an organic solvent may satisfactorily be used. Examples of the organic solvent include acetone, methylene chloride, trichlen, and cyclohexanone.

The development method is with no specific limitation. Generally, methods by immersion development, spray development, brush development and ultrasonic development are done at a developing temperature of 10 to 50° C., preferably 15 to 45° C.

Using the same apparatuses as those for solvent drying, post-bake is done at 150 to 300° C. for one to 120 minutes.

The film thickness of the resulting black matrix is generally 0.1 to 1.5 μm, preferably 0.2 to 1.0 μm. So as to exert the function as black matrix, preferably, the black matrix has an optical density of 3 or more at that film thickness.

On the black matrix pattern prepared at the process, openings of about 20 to 200 μm are arranged between the black matrices. Pixels are formed in that space at the following process.

Then, pixels of plural colors are formed in the openings in the black matrices. Generally, the colors of individual pixels are three colors of R, G and B. The photosensitive compositions are colored by pigments or dyes. First, the photosensitive colored compositions are coated on a transparent substrate with the black matrix pattern arranged thereon.

A layer colored with a first color is formed on the whole surface of the black matrix, by drying the solvent in an oven and the like. Because a color filter comprises pixels of plural colors, generally, unnecessary parts are removed by photolithography, to form a pixel pattern of the desired first color. The film thickness of such pigment is about 0.5 to 3 μm. By repeating the process for pixels of essential colors, pixels of plural colors are formed, to produce a color filter. Preferably, the apparatuses and chemical agents for forming the individual pixels are the same as those for forming the black matrix. However, different apparatuses and chemical agents may satisfactorily be used.

Subsequently, a protective film is overlaid if necessary. The protective film includes but is not limited to any protective film of acryl resin, epoxy resin, silicone resin and polyimide resin.

Other than the method, additionally, there is a method including preliminarily forming patterned pixels on a transparent substrate, coating the black resist composition, exposing the resulting film from the side of the transparent substrate and forming a black matrix between the pixels, using the pixels as a mask (so-called back exposure mode).

Finally, overlaying ITO transparent electrode and patterning are done if necessary by general methods.

The black resist composition using the titanium black and the carbon black in combination in accordance with the invention enabled ready formation of the black matrix with high light resistance and high insulation property and with excellent thin line patterns.

### BEST MODE FOR CARRYING OUT THE INVENTION

The invention is now described below in synthetic examples of the acryl copolymer dispersant (C), synthetic examples of the binder resin (E), a preparation example of a black pigment dispersion solution and Examples. However, the invention is no way limited by these Examples.

### SYNTHETIC EXAMPLE 1

### Synthesis of Acrylic Copolymer Dispersant (DP-1)

Cyclohexanone (40 parts by mass) was placed in a four-necked flask with a reflux cooler, a thermometer, an agitator, and a dropping funnel. The liquid temperature was maintained at 100° C. A mix solution of ethyl acrylate (manufactured by Kyoei Kagaku Kogyo Kabushiki Kaisha; 24 parts by mass), macromonomer-AA-6 (methyl methacrylate monomer; manufactured by Toa Gosei, Co., Ltd.; 4 parts by mass), Light Ester DQ-100 (dimethylaminoethyl methacrylate prepared as quaternary product; manufactured by Kyoei Kagaku Kogyo Kabushiki Kaisha; 12 parts by mass), n-dodecylmercaptan (manufactured by Tokyo Kasei Kabushiki Kaisha; 0.4 part by mass), azobisisobutyronitrile (0.8 part by mass) and cyclohexanone (20 parts by mass) was dropwise added in nitrogen atmosphere over about 3 hours. After termination of dropwise addition, additionally, azobisisobutyronitrile (0.5 part by mass) was added, for reaction at 100° C. for 2 hours. The weight average molecular weight of the resulting copolymer on a polystyrene basis was measured by GPC. The weight average molecular weight thereof was 50,000. The solid concentration was 40.2%. This is defined as “DP-1”.

### SYNTHETIC EXAMPLE 2

### Synthesis of Acrylic Copolymer Dispersant (DP-2)

The composition of the mix solution to be dropwise added to cyclohexanone (40 parts by mass) in Synthetic Example 1 was modified as follows: phenoxyethyl methacrylate (manufactured by Kyoei Kagaku Kogyo Kabushiki Kaisha; Light Ester PQ; 12 parts by mass), macromonomer-AA-6 (4 parts by mass), Light Ester DQ-100 (8 parts by mass), Light Ester DM (dimethylaminoethyl methacrylate (manufactured by Kyoei Kagaku Kogyo Kabushiki Kaisha; 16 parts by mass), n-dodecylmercaptan (2 parts by mass) and azobisisobutyronitrile (0.8 part by mass). Reaction was progressed under the same conditions except the composition. The weight average molecular weight of the resulting copolymer on a polystyrene basis was measured by GPC. The weight average molecular weight thereof was 20,000. The solid concentration was 40.3%. This is defined as “DP-2”.

### SYNTHETIC EXAMPLE 3

### Synthesis of Binder Resin (AP-1)

Methacrylic acid (abbreviated as “MA” hereinafter) (manufactured by Kyoeisha Kagaku Kogyo Kabushiki Kaisha; 75.0 parts by mass), 4-methylstyrene (abbreviated as “PMS” hereinafter) (manufactured by Delteck. Corp.; 88.8 parts by mass), 2-mercaptoethanol (manufactured by Wako Pure Chemical Industries, Ltd.; 0.5 part by weight), and propylene glycol monomethyl ether (abbreviated as “PGM” hereinafter) (manufactured by Tokyo Kasei Kabushiki Kaisha; 262.0 parts by mass) were charged in a four-necked flask with a dropping funnel, a thermometer, and a reflux cooling tube and an agitator, followed by nitrogen substitution of the inside of the four-necked flask for one hour. After the flask was heated to 90° C. in an oil bath, a mix solution of PGM (262.0 parts by mass) and 2,2′-azobisisobutyronitrile (abbreviated as “AIBN” hereinafter) (manufactured by Wako Pure Chemical Industries, Ltd.; 3.2 parts by mass) was dropwise added over one hour. After 3-hour polymerization, the resulting mixture was heated to 100° C., followed by further addition of a mix solution of AIBN (1.0 part by mass) and propylene glycol methyl ether acetate (abbreviated as “PMA” hereinafter) (manufactured by Tokyo Kasei Kabushiki Kaisha; 20.0 parts by mass), for polymerization for 1.5 hours. Then, the temperature was lowered to 60° C.

Subsequently, the inside of the four-necked flask was substituted with air, to which glycidyl methacrylate (abbreviated as “GMA” hereinafter) (manufactured by Tokyo Kasei Kabushiki Kaisha; 59.2 parts by mass), triphenylphosphine (abbreviated as TPP hereinafter) (manufactured by Hokko Chemical Kabushiki Kaisha; 4.2 parts by mass) and methoquinone (manufactured by Jyunsei Chemical Kabushiki Kaisha; 0.34 part by mass) were added, for reaction at 100° C. for 10 hours, to add GMA to the carboxyl group of the acryl copolymer. The resulting GMA-added acryl copolymer is defined as “AP-1”. The solid concentration of AP-1 was 30.5%; the acid value of the solids was 120 mg KOH/g; and the weight average molecular weight on a polystyrene basis as measured by GPC was 15,000.

### SYNTHETIC EXAMPLE 4

### Synthesis of Binder Resin (AP-2)

MA (35.0 parts by mass), methyl methacrylate (abbreviated as “MMA” hereinafter) (manufactured by Kyoeisha Kagaku Kogyo Kabushiki Kaisha; 60.0 parts by mass), benzyl methacrylate (abbreviated as “BzMA” hereinafter) (manufactured by Kyoeisha Kagaku Kogyo Kabushiki Kaisha; 15.0 parts by mass), 2-hydroxyethyl methacrylate (abbreviated as “HEMA” hereinafter) (manufactured by Kyoeisha Kagaku Kogyo Kabushiki Kaisha; 40.0 parts by mass), 2-mercaptoethanol (1.5 parts by mass), and PMA (225.0 parts by mass) were charged in a four-necked flask with a dropping funnel, a thermometer, a cooling tube, and an agitator, followed by nitrogen substitution of the inside of the four-necked flask for one hour. After the flask was heated to 90° C. in an oil bath, a mix solution of PMA (225.0 parts by mass) and AIBN (3.2 parts by mass) was dropwise added over one hour. After 3-hour polymerization, the resulting solution was heated to 100° C., followed by addition of a mix solution of AIBN (1.0 part by mass) and PMA (15.0 parts by mass) for another 1.5-hour polymerization. Subsequently, the temperature was lowered to 60° C. Then, the inside of the four-necked flask was substituted with air, to which 2-methacryloxyethyl isocyanate ethyl (abbreviated as “IEM” hereinafter) (manufactured by Showa Denko Kabushiki Kaisha; 48.0 parts by mass), dibutyltin dilaurate (0.15 part by mass) and methoquinone (0.15 part by mass) were added, for reaction at 60° C. for 5 hours, to add IEM to the hydroxyl group of the acryl copolymer.

The resulting IEA-added acryl copolymer is defined as “AP-2”. The solid concentration of AP-2 was 29.5%; the acid value of the solids was 114 mg KOH/g; and the weight average molecular weight on a polystyrene basis as measured by GPC was 13,000.

Preparation of Black Pigment Dispersion Solutions BD-1 through BD-14

The titanium black and carbon black used are shown below in Tables 1 and 2.

TABLE 1
Titanium black types

| | Primary particle | Specific surface area |
|---|---|---|
| Titanium black | size (nm) | (BET-m²/g) |
| 13-MC | 100 | 20 |
| Tilack D | 60 | 50 |

TABLE 2
Carbon black types

| | Primary particle | Specific surface area |
|---|---|---|
| Carbon black | size (nm) | (BET-m²/g) |
| Special Black 250 | 55 | 40 |
| Raven 1080 | 30 | 85 |
| Special Black 4 | 25 | 180 |

After AP-1 (14.0 parts by mass (solid content at 4.2 parts by mass)) as a binder resin, DP-1 (4.5 parts by mass (solid content at 1.8 parts by mass)) as a dispersant, carbonblack Special Black 250 (abbreviated as “SB250” hereinafter) (manufactured by Degussa; 14.0 parts by mass) and PMA as an organic solvent (67.6 parts by mass) were mixed together, the resulting mixture was pre-mixed together with a disperser. Further, the mix solution was dispersed with a continuous annular type bead mill (Spike Mill under trade name; Type SHG-4 manufactured by Inoue Seisakusho), to obtain a carbon black dispersion solution.

Zirconia bead of a diameter of 0.65 mm was used as the bead. The bead-packing ratio in the vessel was 80% by volume. It was preset that the peripheral rotor velocity might be 12 m/s; the injection volume of the carbon black dispersion solution might be one liter/min; and the temperature might be about 30° C. The retention time of the carbon black dispersion solution in the vessel was 6 minutes (one-hour operation time).

Additionally, DP-1 as a dispersant (2.8 parts by mass (solid content at 1.2 parts by mass)), titanium black 13M-C (manufactured by Jemco, Inc.; 8.8 parts by mass) and PMA as an organic solvent (28.3 parts by mass) were mixed together. Subsequently, the resulting mixture was pre-mixed together with a disperser. Further, the mix solution was dispersed with the continuous annular type bead mill in the same manner, to obtain a titanium black dispersion solution.

The carbon black dispersion solution and the titanium black dispersion solution were mixed together, to obtain a black pigment dispersion solution “BD-1”. The composition of BD-1 is shown in Table 3.

Black pigment dispersion solutions BD-2 through BD-14 of compositions shown in Table 3 were obtained by the same method.

Preparation of Black Pigment Dispersion Solutions BD-15 through BD-20

After AP-2 (14.0 parts by mass (solid content at 4.2 parts by mass)), DP-1 (7.3 parts by mass (solid content at 3.0 parts by mass)), SB250 (15.0 parts by mass), 13M-C (25 parts by mass), and PMA (95.9 parts by mass) were mixed together, the resulting mixture was pre-mixed together with a disperser. Further, the mix solution was dispersed with a continuous annular type bead mill in the same manner as in Example 1, to obtain a black pigment dispersion solution “BD-15”. The composition of BD-15 is shown in Table 3.

Black pigment dispersion solutions BD-16 through BD-20 of compositions shown in Table 3 were obtained by the same method.

TABLE 3
Blend composition of black pigment dispersion solution-1

| | Blend composition of black pigment dispersion solution (in part by mass) | | | | | | | |
|---|---|---|---|---|---|---|---|---|
| | Composition of solid is shown in ( ). | | | | | | | |
| | BD-1 | | BD-2 | | BD-3 | | BD-4 | |
| Binder resin | AP-1 | 14 (4.2) | AP-1 | 14 (4.2) | AP-1 | 14 (4.2) | AP-1 | 14 (4.2) |
| Dispersant | DP-1 | 7.3 (3.0) | DP-2 | 7.3 (3.0) | DP-1 | 7.3 (3.0) | DP-2 | 7.3 (3.0) |
| Titanium black | 13-MC | 8.8 | 13-MC | 8.8 | Tilack D | 8.8 | Tilack D | 8.8 |
| Carbon black | Special Black | 14 | Special Black | 14 | Special Black | 14 | Special Black | 14 |
| | 250 | | 250 | | 250 | | 250 | |
| Organic solvent | PMA | 95.9 | PMA | 95.9 | PMA | 95.9 | PMA | 95.9 |

| | | | | |
|---|---|---|---|---|
| Prepared black resist | SBM-1 | SBM-2 | SBM-3 | SBM-4 |
| composition | | | | |

Blend composition of black pigment dispersion solution-2

| | Blend composition of black pigment dispersion solution(in part by mass) | | | | | | | |
|---|---|---|---|---|---|---|---|---|
| | Composition of solid is shown in ( ). | | | | | | | |
| | BD-5 | | BD-6 | | BD-7 | | BD-8 | |
| Binder resin | AP-1 | 14 (4.2) | AP-2 | 14 (4.2) | AP-1 | 14 (4.2) | AP-2 | 14 (4.2) |
| Dispersant | DP-1 | 7.3 (3.0) | DP-2 | 7.3 (3.0) | DP-1 | 7.3 (3.0) | DP-2 | 7.3 (3.0) |
| Titanium black | 13-MC | 30 | Tilack D | 40 | 13-MC | 35 | 13-MC | 35 |
| Carbon black | Raven 1080 | 15 | Raven 1080 | 10 | Special Black | 30 | Raven 1080 | 30 |
| | | | | | 250 | | | |
| Organic solvent | PMA | 95.9 | PMA | 95.9 | PMA | 95.9 | PMA | 95.9 |

| | | | | |
|---|---|---|---|---|
| Prepared black resist | SBM-5 | SBM-6 | SBM-7 | SBM-8 |
| composition | | | | |

Blend composition of black pigment dispersion solution-3

| | Blend composition of black pigment dispersion solution (in part by mass) | | | | | | | |
|---|---|---|---|---|---|---|---|---|
| | Composition of solid is shown in ( ). | | | | | | | |
| | BD-9 | | BD-10 | | BD-11 | | BD-12 | |
| Binder resin | AP-1 | 14 (4.2) | AP-1 | 14 (4.2) | AP-2 | 14 (4.2) | AP-2 | 14 (4.2) |
| Dispersant | DP-1 | 7.3 (3.0) | DP-2 | 7.3 (3.0) | DP-1 | 7.3 (3.0) | DP-2 | 7.3 (3.0) |
| Titanium black | 13-MC | 80 | Tilack D | 35 | 13-MC | 25 | 13-MC | 10 |
| Carbon black | Raven 1080 | 5 | Raven 1080 | 30 | Special Black | 15 | Special Black 4 | 55 |
| | | | | | 250 | | | |
| Organic solvent | PMA | 95.9 | PMA | 95.9 | PMA | 95.9 | PMA | 95.9 |

| | | | | |
|---|---|---|---|---|
| Prepared black resist | SBM-9 | SBM-10 | SBM-11 | SBM-12 |
| composition | | | | |

Blend composition of black pigment dispersion solution-4

| | Blend composition of black pigment dispersion solution (in part by mass) | | | | | | | |
|---|---|---|---|---|---|---|---|---|
| | Composition of solid is shown in ( ). | | | | | | | |
| | BD-13 | | BD-14 | | BD-15 | | BD-16 | |
| Binder resin | AP-2 | 14 (4.2) | AP-2 | 14 (4.2) | AP-2 | 14 (4.2) | AP-1 | 14 (4.2) |
| Dispersant | DP-1 | 7.3 (3.0) | DP-2 | 7.3 (3.0) | DP-1 | 7.3 (3.0) | DP-2 | 7.3 (3.0) |
| Titanium black | 13-MC | 25 | Tilack D | 35 | 13-MC | 25 | Thack D | 35 |
| Carbon black | Raven 1080 | 15 | Special Black 4 | 30 | Special Black | 15 | Raven 1080 | 30 |
| | | | | | 250 | | | |
| Organic solvent | PMA | 95.9 | PMA | 95.9 | PMA | 95.9 | PMA | 95.9 |

| | | | | |
|---|---|---|---|---|
| Prepared black resist | SBM-13 | SBM-14 | SBM-15 | SBM-16 |
| composition | | | | |

Blend composition of black pigment dispersion solution-5

| | Blend composition of black pigment dispersion solution (in part by mass) | | | | | | | |
|---|---|---|---|---|---|---|---|---|
| | Composition of solid is shown in ( ). | | | | | | | |
| | BD-17 | | BD-18 | | BD-19 | | BD-20 | |
| Binder resin | AP-1 | 14 (4.2) | AP-1 | 14 (4.2) | AP-1 | 14 (4.2) | AP-1 | 14 (4.2) |
| Dispersant | DP-1 | 7.3 (3.0) | DP-2 | 7.3 (3.0) | DP-1 | 7.3 (3.0) | DP-2 | 7.3 (3.0) |
| Titanium black | 13-MC | 0 | 14-MC | 3 | Tilack D | 80 | Tilack D | 50 |
| Carbon black | Special Black | 50 | Special Black | 50 | Special Black | 3 | Special Black | 0 |
| | 250 | | 250 | | 250 | | 250 | |
| Organic solvent | PMA | 95.9 | PMA | 95.9 | PMA | 95.9 | PMA | 95.9 |

| | | | | |
|---|---|---|---|---|
| Prepared black resist | SBM-17 | SBM-18 | SBM-19 | SBM-20 |
| composition | | | | |

Preparation of Black Resist Composition

### EXAMPLE 1

### Preparation of Black Resist Composition SBM-1

The black pigment dispersion solution BD-1 (140 parts by mass), AP-1 (30.0 parts by mass), dipentaerythritol hexaacrylate (abbreviated as “DPHA” hereinafter; manufactured by To a Gosei Co., Ltd.) (2.5 parts by mass) as an ethylenic unsaturated monomer (monomer), (4,4′-bis(N,N-diethylamino)benzophenone as a photopolymerization initiator (abbreviated as “EMK” hereinafter; manufactured by Hodogaya Kagaku Kabushiki Kaisha; 0.2 part by mass), MHABI (2.5 parts by mass), TPMB as a polyfunctional thiol compound (manufactured by Showa Denko Co., Ltd.) (1.0 part by mass) and PMA (80 parts by mass) were mixed together and agitated together for 2 hours. Then, the resulting mixture was filtered through a filter of a pore size of 0.8 μm (Kiriyama filter for GFP use), to prepare a black resist composition “SBM-1”.

### EXAMPLES 2 THROUGH 10

### Preparation of Black Resist Compositions SBM-2 through SBM-10

In the same manner as in Example 1, black resist compositions SBM-2 through SBM-10 were prepared, using BD-2 through BD-10.

### EXAMPLES 11 AND 12

### Preparation of Black Resist Compositions SBM-11 and SBM-12

In the same manner as in Example 1 except for the use of AP-2 instead of AP-1 in Example 1, black resist compositions SBM-11 and SBM-12 were prepared, using BD-11 and BD-12.

### EXAMPLES 13 AND 14

### Preparation of Black Resist Compositions SBM-13 and SBM-14

In the same manner as in Example 1 except for the use of bisphenol A type epoxyacrylate (epoxy equivalence of 950; acid value of 115; solid content at 40%; manufactured by Showa Denko Co., Ltd.) instead of AP-1 in Example 1, black resist compositions SBM-13 and SBM-14 were prepared, using BD-13 and BD-14.

### EXAMPLES 15 AND 16

### Preparation of Black Resist Compositions SBM-15 and SBM-16

In the same manner as in Example 1 except for the use of bisphenol A type epoxyacrylate (solid content at 40%; epoxy equivalence of 950; acid value of 115; manufactured by Showa Kobunshi Co., Ltd.) instead of AP-11 in Example 1, black resist compositions SBM-15 and SBM-16 were prepared, using BD-15 and BD-16.

### COMPARATIVE EXAMPLES 1 THROUGH 4

### Preparation of Black Resist Compositions SBM-17 through SBM-20

In the same manner as in Example 2, black resist compositions SBM-17 through SBM-20 were prepared, using BD-17 through BD-20.

[Evaluation of Black Resist Compositions]

The following properties of the black resist compositions of Examples 1 through 16 and Comparative Examples 1 through 4 were evaluated.

<Dispersibility>

Dispersibility was evaluated on the basis of the filtration property and gloss of a black resist composition.

Filtration property was evaluated on the following standards, when the black resist composition was to be obtained.
O: rapidly filtered.
x: clogged with difficulty in filtration.

The results are shown in Table 4.

<Gloss>

Gloss was measured by coating a black resist composition on a glass plate of a size of 100×100×1 mm by spin coating, drying the plate in vacuum under reduced pressure at ambient temperature for 2 minutes and at 80° C. for 5 minutes, and subsequently measuring the gloss under conditions of an incidence angle of 45° and a reflection angle of 45°, using a digital deformation gloss meter (Type UGV-50; manufactured by Suga Testing Machine Kabushiki Kaisha). It was determined that a larger gloss showed better dispersibility of black resist composition. The results are shown in Table 4.

<Photosensitivity>

A black resist composition was spin-coated on a glass plate (size of 100×100×1 mm) to a dry film thickness of about 1 μm, which was then dried in vacuum under reduced pressure at ambient temperature for 2 minutes and at 80° C. for 5 minutes. After the film thickness of the resist was preliminarily measured with a film thickness meter (SURFCOM130A manufactured by Tokyo Seimitsu Kabushiki Kaisha), the resist was thermally cured through a quartz photomask, while changing the exposure level with an exposure apparatus with an ultra-high pressure mercury lamp integrated therein (manufactured by Ushio Co., Ltd.; Multilight ML-251A/B under trade name). The exposure level was measured, using UV integration luminous meter (manufactured by Ushio Co., Ltd.; UIT-150 under trade name; UVD-S365 as receptor) Further, a quartz-made photomask was used.

The exposed resist was then developed in an aqueous solution containing Developer 9033 as an alkali-developing agent containing potassium carbonate (manufactured by Shipley Far East Ltd.) at 0.25% and sodium dodecylbenzene sulfonate (manufactured by Tokyo Kasei Kabushiki Kaisha) at 0.03% (at 25° C.) for a given period of time (the developing time was set to 1.5-fold the time (tD) until the film before exposure was completely dissolved via alkali development; tD=15 seconds in this Example). After alkali development, the glass plate was washed in water and dried in air spray, to measure the film thickness of the residual resist to calculate the residual film ratio. The residual film ratio was calculated by the following formula. The same photosetting procedure was repeatedly carried out, while changing the exposure level, to prepare a graph plotting the relation between the exposure level and the residual film ratio to determine the exposure level when the residual film ratio was saturated.
Residual film ratio (%)=[film thickness after alkali development/film thickness before alkali development]×100

Then, the line width of the resist formed with a 10-μm part of the line/space of the photomask was measured by an optical microscope (manufactured by KEYENCE Co., Ltd.; VH-Z250).

By the method, the exposure level at which the residual film ratio after alkali development was saturated and was the same line width as the line width (10 μm) of the photomask was defined as photosensitivity. The results are shown in Table 4.

<Resolution Level>

Resolution level of a black resist composition was determined by photo-setting the black resist composition at an exposure level corresponding to the photosensitivity according to the evaluation of photosensitivity, subsequent alkali development by the same method, and determining the minimum line width at which the same line width as that of photomask remained and defining the minimum line width as the resolution level of the black resist composition. The results are shown in Table 4.

<Optical Density (OD Value)>

A black resist composition was spin-coated on a glass plate (size of 100×100), which was then dried in vacuum under reduced pressure at ambient temperature for 2 minutes and at 80° C. for 5 minutes. After the resist was thermally cured at an exposure level corresponding to the photosensitivity of each resist with an ultra-high-pressure mercury lamp, the resist was post-baked at 230° C. for 30 minutes, to measure the OD value using the glass plate with the resulting resist coated thereon. A standard curve was prepared by measuring the transmittance levels of standard plates with known OD values at 550 nm. By measuring the transmittance level of glass plates with coated resists of the individual Examples and Comparative Examples at 550 nm, then, the OD values were calculated. The results are shown in Table 4.

<Surface Resistance>

A black resist composition was spin-coated on a glass plate (size of 100×100), which was then dried in vacuum under reduced pressure at ambient temperature for 2 minutes and at 80° C. for 5 minutes. After the resist was thermally cured at an exposure level corresponding to the photosensitivity of each resist with an ultra-high-pressure mercury lamp, the resist was post-baked at 230° C. for 30 minutes, to measure the glass plate with the resulting resist coated thereon using a resistance meter (High Resta UP, MCP-HT450% Type; manufactured by Mitsubishi Kagaku Kabushiki Kaisha). The results are shown in Table 4.

TABLE 4
Results of evaluation of black resist compositions of Examples
1 through 16 and Comparative Examples 1 through 4

| | | Dispersibility | | OD | Surface | Photo- | Resolution |
|---|---|---|---|---|---|---|---|
| | Black resist | Filtration | 45° | value/ | resistance | sensitivity | level |
| | composition | property | Gloss | μm | Ω/cm² | mj/cm² | μm |
| Example 1 | SBM-1 | ∘ | 148 | 3.2 | 10¹³ | 40 | 4 |
| Example 2 | SBM-2 | ∘ | 146 | 3.3 | 10¹³ | 40 | 4 |
| Example 3 | SBM-3 | ∘ | 145 | 3.2 | 10¹² | 40 | 4 |
| Example 4 | SBM-4 | ∘ | 146 | 3.4 | 10¹² | 40 | 4 |
| Example 5 | SBM-5 | ∘ | 145 | 4.0 | 10¹³ | 70 | 4 |
| Example 6 | SBM-6 | ∘ | 142 | 4.7 | 10¹³ | 100 | 6 |
| Example 7 | SBM-7 | ∘ | 148 | 5.3 | 10¹² | 120 | 4 |
| Example 8 | SBM-8 | ∘ | 150 | 5.0 | 10¹² | 100 | 4 |
| Example 9 | SBM-9 | ∘ | 142 | 5.5 | 10¹³ | 120 | 6 |
| Example 10 | SBM-10 | ∘ | 150 | 5.1 | 10¹² | 100 | 4 |
| Example 11 | SBM-11 | ∘ | 147 | 4.5 | 10¹³ | 100 | 4 |
| Example 12 | SBM-12 | ∘ | 140 | 4.8 | 10¹¹ | 100 | 6 |
| Example 13 | SBM-13 | ∘ | 145 | 3.8 | 10¹³ | 70 | 4 |
| Example 14 | SBM-14 | ∘ | 142 | 5.2 | 10¹² | 100 | 4 |
| Example 15 | SBM-15 | ∘ | 145 | 4.5 | 10¹³ | 90 | 4 |
| Example 16 | SBM-16 | ∘ | 143 | 5.0 | 10¹² | 100 | 4 |
| Comparative | SBM-17 | x | 98 | 4.3 | 10⁶ | 100 | 10 |
| Example 1 | | | | | | | |
| Comparative | SBM-18 | x | 100 | 4.6 | 10⁷ | 100 | 10 |
| Example 2 | | | | | | | |
| Comparative | SBM-19 | x | 100 | 5.3 | 10¹³ | 120 | 12 |
| Example 3 | | | | | | | |
| Comparative | SBM-20 | x | 98 | 4.4 | 10¹³ | 100 | 10 |
| Example 4 | | | | | | | |

The results in Table 4 show that a resist composition with higher dispersibility of pigment components can be obtained via the combined use of the specific titanium black and carbon black and that a black resist composition for color filter can be obtained, which has high sensitivity and resolution level as well as high surface resistance while it can maintain the high light resistance of the carbon black.

### INDUSTRIAL USE

The black resist composition for color filter in accordance with the invention is produced by using titanium black and carbon black in combination, so that the black resist composition can highly maintain the dispersion state and can give high surface resistance while the black resist composition maintains the high light resistance of carbon black. Thus, the resist composition of the invention can prepare a black matrix for color filter into a thinner film. Therefore, the resist composition is so useful.

1. A black resist composition for color filter, the black resist composition containing titanium black (A) with an average primary particle size of 110 nm or less and carbon black (B) with an average primary particle size of 60 nm or less, where the ratio in mass between the titanium black (A) and the titanium black (B) is 100:5 to 1000.

2. The black resist composition for color filter as claimed in claim 1, where the titanium black (A) is low-level titanium oxide.

3. A black resist composition for color filter, the black resist composition containing titanium black (A) with an average primary particle size of 110 nm or less, carbon black (B) with an average primary particle size of 60 nm or less, an acrylic copolymer dispersant (C) with an amino group and/or a quaternary ammonium salt and an organic solvent (D).

4. The black resist composition for color filter as claimed in claim 3, the black resist composition additionally containing a binder resin (E) with a carboxyl group and an ethylenic unsaturated group.

5. The black resist composition for color filter as claimed in claim 4, where the binder resin (E) is an epoxy(meth)acrylate resin with a carboxyl group.

6. The black resist composition for color filter as claimed in claim 3, where the acrylic copolymer dispersant (C) with an amino group and/or a quaternary ammonium salt contains a (meth)acrylate-series monomer described below in (i) and/or (ii) as a copolymerization component:
(i) 10 to 85 parts by mass of at least one selected from the group consisting of (meth)acrylate alkyl ester where the alkyl moiety contains an alkyl group with one to 18 carbon atoms, (meth)acrylate ester represented by the following formula (1) 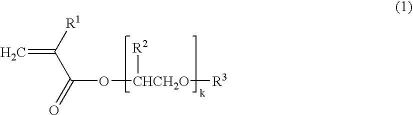
(in the formula, R¹ and R² independently represent a hydrogen atom or a methyl group; R³ represents an alkyl group with one to 18 carbon atoms; and k represents an integer of one to 50), (meth)acrylate ester represented by the following formula (2): 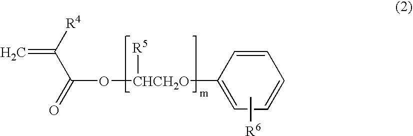
(in the formula, R⁴ and R⁵ independently represent a hydrogen atom or a methyl group; R⁶ represents an alkyl group with one to 18 carbon atoms; and m represents an integer of one to 50), and a (meth)acrylate ester with a hydroxyl group to 100 parts by mass of the acrylic copolymer dispersant (C); and
(ii) 15 to 90 parts by mass of an aminoalkyl (meth)acrylate monomer represented by the following formula (3): 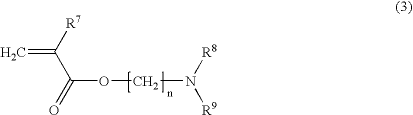
(in the formula, R⁷ represents a hydrogen atom or a methyl group; R⁸ and R⁹ independently represent a hydrogen atom or an alkyl group with one to 6 carbon atoms; and n represents an integer of 2 to 8), and/or a quaternary ammonium (meth)acrylate monomer represented by the following formula (4): 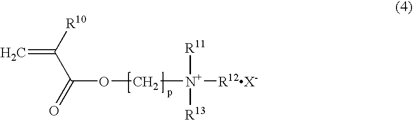
(in the formula, R¹⁰ represents a hydrogen atom or a methyl group;
R¹¹, R¹² and R¹³ independently represent an alkyl group with one to 6 carbon atoms, a hydroxyalkyl group with 2 to 6 carbon atoms, an alkoxyalkyl group with one to 4 carbon atoms, a cycloalkyl group, an aralkyl group or a phenyl group which may or may not be substituted; X⁻ represents a halogen anion or an acid anion residue; and p represents an integer of 2 to 8) to 100 parts by mass of the acrylic copolymer dispersant (C).

7. The black resist composition for color filter as claimed in any one of claims 3 to 6, where the ratio in mass of the total of the titanium black as the component (A) and the carbon black as the component (B) to the acrylic copolymer dispersant (C) with an amino group and/or a quaternary ammonium salt is 100:3 to 25.
